(19) United States
(12) Patent Application Publication
(10) Pub. No.: US 2013/0097901 A1
(43) Pub. Date: Apr. 25, 2013

(54) PLAY TOYS AND TECHNIQUES FOR FABRICATING PLAY TOYS

(71) Applicant: John Scott Cooper, Ft. Lauderdale, FL (US)

(72) Inventor: John Scott Cooper, Ft. Lauderdale, FL (US)

(21) Appl. No.: 13/646,314

(22) Filed: Oct. 5, 2012

Related U.S. Application Data
(60) Provisional application No. 61/543,431, filed on Oct. 5, 2011.

(51) Int. Cl. A01K 11/00; G09F 3/00; A63H 5/00

(52) U.S. Cl. CPC A01K 15/026; A63H 5/00; G09F 3/00
USPC 40/299.01; 446/397; 446/188; 446/77; 119/709

(57) ABSTRACT

A play toy has a body and at least one noise making device disposed in the body for producing an audible sound upon shaking or compression of the noise making device via the body. In one embodiment, the at least one sound producing device comprises two noise making devices for simultaneously producing two distinctly different audible sounds. In another embodiment, the body is a braided body formed of strands of materials braided together.

### BACKGROUND OF THE INVENTION

1. Field of the Invention

The present invention relates generally to the field of toys and, more specifically, to play toys and techniques for fabricating play toys which incorporate one or more sound or noise producing components.

2. Background Information

It is desirable to provide pets and, in particular, dogs, with play toys that will entertain the pet and occupy the pet's attention for extended periods of time. Generally, play toys for dogs include chew, fetch, and tug types or combinations thereof. It is also desirable to provide play toys for children that will provide entertainment for extended periods of time, are soft to the touch, are easily carried and manipulated by children, and are long-lasting, safe and non-hazardous to play with.

In order to maximize the stimulation provided by playing with such play toys, it has been desirable to configure such play toys such that they provide audible stimulation in addition to visual and tactile stimulation. This has been heretofore accomplished by incorporating a sound producing component into the play toy, such as a noise making element or device that produces an audible sound when squeezed or shaken.

Moreover, chewing and gnawing on suitable articles are commonly known to be of benefit to pet animals, particularly pet dogs. Repeated chewing and gnawing is beneficial to a dog's oral health as it strengthens and exercises the dog's teeth and jaws. The chewing and gnawing action tends to scrape tartar, plaque, and debris from the dog's teeth.

However, existing play toys incorporating sound producing components have been unable to retain the interest levels of pets and children using such play toys. For pet animals, in particular, existing pet toys have been unable to maintain the interest of pets for an amount of time sufficient to allow the pets to benefit from the teeth cleaning action resulting from the repeated chewing and gnawing of the play toys by pets.

### SUMMARY OF THE INVENTION

Play toys and techniques for fabricating play toys incorporating components for producing one or more audible sounds, as well as play toys with braided bodies incorporating such sound producing components, are described herein.

In one aspect, the present invention provides a play toy comprising a body and sound producing means disposed in the body for producing a plurality of distinctly different audible noises or sounds.

In another aspect, the present invention provides a play toy comprising a plurality of parts connected together to form a three-dimensional-shaped play toy, one of the parts comprising a body and sound producing means disposed in the body for producing a plurality of distinctly different audible noises.

In another aspect, the present invention provides a play toy comprising a plurality of strands of materials braided together to form a braided body having a pre-selected cross-sectional shape, and sound producing means disposed in the braided body for producing an audible noise or sound upon compression of the sound producing means via the braided body.

In yet another aspect, the present invention provides a play toy comprising a plurality of strands of materials braided together to form a braided body having a pre-selected cross-sectional shape, and sound producing means disposed in the braided body for producing an audible noise or sound upon a shaking movement of the sound producing means via the braided body.

In yet another aspect, the present invention provides an advertising device comprising a play toy according any of the foregoing aspects and advertising indicia disposed at least on the body of the play toy.

In exemplary designs, the inventive techniques are used for fabricating chew, fetch, and tug types of pet toys or combinations thereof, as well as play toys suitable for use by small children and children with special needs. Various aspects and embodiments of the invention are described in further detail below.

The foregoing summary is neither intended nor should it be construed as being representative of the full extent and scope of the present invention, which these and additional aspects will become more readily apparent from the detailed description, particularly when taken together with the appended drawings.

### BRIEF DESCRIPTION OF THE DRAWINGS

The foregoing summary, as well as the following detailed description of the preferred embodiments of the invention, will be better understood when read in conjunction with the accompanying drawings. For the purpose of illustrating the invention, there is shown in the drawings embodiments which are presently preferred. It should be understood, however, that the invention is not limited to the precise arrangement and instrumentalities shown. In the drawings:

FIG. 1 is a front view of a play toy according to a first embodiment of the present invention;

FIG. 2 is a front view in partial cross-section of the play toy according to the first embodiment of the present invention;

FIG. 3 is a front view of a modified form of the play toy according to the first embodiment of the present invention;

FIGS. 4A-4B show a play toy according to a second embodiment of the present invention, where FIG. 4A is a side view in full and FIG. 4B is a cross-sectional view taken along line 4B-4B in FIG. 4A; and

FIGS. 5A-5B show a play toy according to a third embodiment of the present invention, where FIG. 5A is a front view in full and FIG. 5B is a partial cross-sectional view showing the sound producing component inside the braided body of the play toy.

### DETAILED DESCRIPTION OF THE PREFERRED EMBODIMENTS

The images in the drawings are simplified for illustrative purposes and are not depicted to scale. To facilitate understanding, identical reference numerals have been used, where possible, to designate identical elements that are common to the figures, except that suffixes may be added, when appropriate, to differentiate such elements.

The appended drawings illustrate exemplary embodiments of the invention and, as such, should not be considered as limiting the scope of the invention that may admit to other equally effective embodiments. It is contemplated that features or steps of one embodiment may be beneficially incorporated in other embodiments without further recitation.

The term “exemplary” is used herein to mean “serving as an example, instance, or illustration.” Any embodiment or design described herein as “exemplary” or “alternative” is not necessarily to be construed as preferred or advantageous over other embodiments or designs.

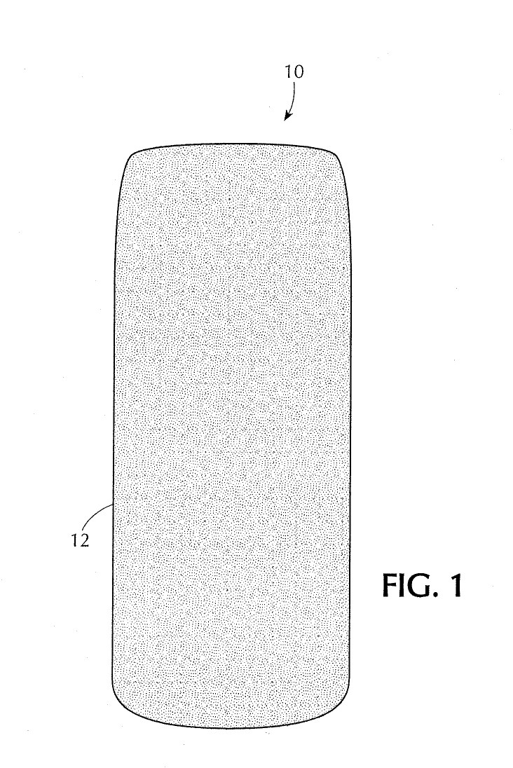

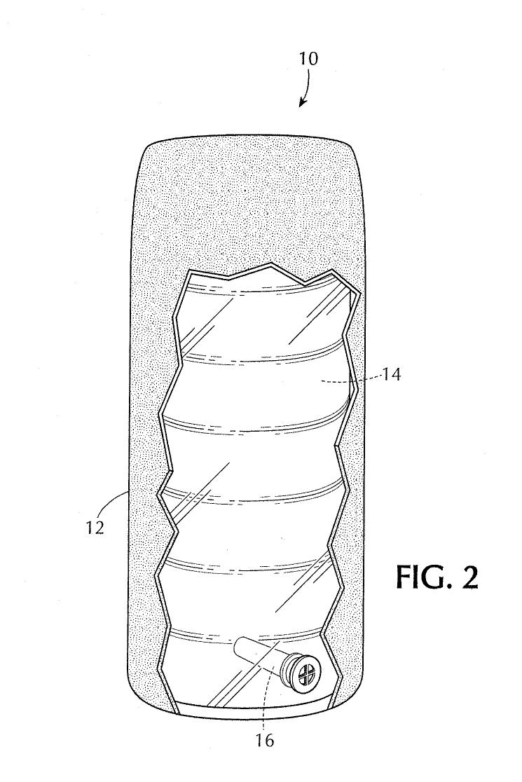

FIGS. 1-2 show a play toy, generally designated at 10, according to a first embodiment of the present invention. The play toy 10 includes an outer covering or body 12 and sound producing means incorporated inside of the body 12. The body 12 is preferably made of a durable fabric material that is soft to the touch, such as a plush-like material, and that does not significantly muffle the sound or noise generated by the sound producing means incorporated therein as described below.

The body 12, which is generally cylindrical in shape in this embodiment, is formed of one or more pieces of fabric material joined together by perimeter stitching (not shown) after insertion therein of the sound producing means to form the body 12 into the cylindrical shape. Alternatively, the body 12 is formed into the generally cylindrical shape by perimeter stitching and provided with portions that are not stitched to form an opening via which the sound producing components may be introduced and removed from the interior of the body 12. In this case, the portions of the body 12 forming the opening are preferably provided with removable connecting elements (e.g., VELCRO® connectors) to allow the opening to be securely closed when the play toy is in use while allowing the interior of the body 12 to be readily accessed for replacement of the sound producing means, for example.

As shown in FIG. 2, in the present embodiment the sound producing means comprises two sound producing components or noise making devices 14, 16 which produce distinctly different audible noises or sounds when activated. More specifically, the first noise making device 14 is a compressible member with a tubular body that produces a crinkle sound (first sound) when compressed or squeezed. The tubular body, which defines the shape of the play toy 10 when covered with the outer covering or body 12, is made of a material which allows the body to return to the uncompressed state after the body has been compressed. A feature of the present invention is that the crinkle sound is produced both during compression or squeezing of the tubular body and while the tubular body returns to its uncompressed state. As further described below, during compression the tubular body of the noise making device 14 changes in volume and generates an air flow within a cavity of the tubular body that is utilized to produce a second sound distinct from the abovementioned first sound.

Various materials are suitable for the compressible tubular member forming the first noise making device 14. For example, a plastic material such as polyethylene terephthalate (PET or PETE) and high density polyethylene (HDPE) provide the requisite compressibility and crinkle sound generating capability for accomplishing the foregoing objective of the present invention. PET or PETE and HDPE have been particularly recognized as safe plastic materials in that they are not known to leach any harmful chemicals. These materials are currently in used to make soft drink, water, juice and milk plastic bottles.

In one particularly preferred exemplary embodiment, the compressible member forming the first noise making device 14 is a recycled plastic water bottle that is covered by the outer covering 12 and with the open end of the bottle sealed (e.g., capped) to allow air inside the bottle to flow in and out of the second noise making device 16 as further described below. The use of recycled plastic water bottles in the exemplary embodiment of the play toy 10 according to the present invention assists in the significant reduction of waste and landfill.

In the present embodiment, the second noise making device 16 is a squeaker mechanism or squeak device of the type that produces a squeaking or whistling sound when air flows through it. The squeak device includes a tubular body having a first end via which air is introduced and a second end with a squeak or whistle portion that produces the squeaking or whistling sound when air flows through it. These types of squeak devices are well-known in the art and are incorporated herein by reference.

The squeak device is held in a retaining groove (not shown) formed in the surface of the tubular body of the first noise making device 14 so that its first end is disposed within the cavity of the tubular body and the squeak or whistle portion is exposed to the exterior of the tubular body, as shown in FIG. 2. By this construction, the cavity of the tubular body of the noise making device 14 changes in volume as the tubular body is compressed or squeezed and this causes air within the cavity to flow through the squeak device via the first and second ends thereof and produce a characteristic whistling or squeaking noise. Simultaneously with the generation of this whistling or squeaking noise by the squeak device, the tubular body of the first noise making device 14 produces the crinkle sound during both compression of the tubular body and while the tubular body returns to its uncompressed state.

By the foregoing construction and operation, the play toy 10 according to the present invention simultaneously produces two distinctly different audible noises or sounds by a single operation or activation of the play toy (i.e., compression or squeezing of the tubular body of the first noise making device 14 will produce the crinkle sound and activate the squeak device to produce the whistling or squeaking sound). Thus, an animal or child grasping and repeatedly compressing or squeezing the play toy 10 will cause the play toy to produce the two distinctly different audible noises or sounds, providing amusement and/or interest.

The squeak device 16 can be of a one-way squeak-type, in which the squeak device 16 squeaks as air enters into the cavity of the noise making device 14 (e.g., capped water bottle) via the squeak device 16 during decompression of the noise making device 14 or as air exists from the cavity of the noise making device 14 via the squeak device 16 during compression of the noise making device 14. Alternatively, the squeak device 16 can be a two-way squeak-type, in which the squeak device 16 squeaks both when air enters into and exits from the cavity of the noise making device 14. Both squeak-types are well-known in the art and are incorporated herein by reference.

It will be appreciated that while the play toy 10 in the exemplary embodiment has a generally cylindrical shape, other shapes are suitable for the play toy 10, such as a generally spherical or cubic shape. The outer covering or body 12 may also be made of a chew-resistant fabric material, such as nylon sheeting or polyester cloth or ragging. Additionally, the second noise making device 14 may be selected from among a large number of different noise making elements which operate on the principle of air being forced through a tortuous path and/or a constricted opening or slit. Any of these conventional noise making devices may be used for the second noise making device 14 without departing from the spirit and scope of the present invention. A variety of different sounds can be produced from these conventional noise making elements. For example, low pitch sound producing elements may be used to simulate the sound of an animal, such as a cow. High pitch, whistle type elements may also be used.

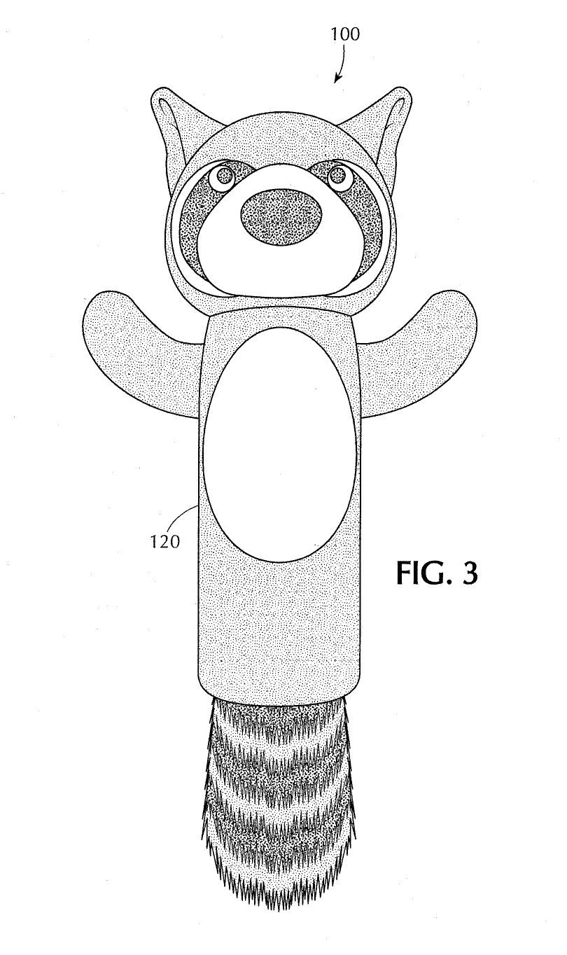

FIG. 3 shows a modified form of the play toy 10 according to the first embodiment. In FIGS. 1-2, the play toy 10 is of a non-character type, that is, it does not resemble an animate figure (e.g., person or animal). In the modified form shown in FIG. 3, the play toy, generally designated at 100, is of a character type, that is, it is shaped three-dimensionally to form an animate figure. The play toy 100 includes a body portion 120 as well as other portions forming the animate figure, including head, ears, hands and tail portions. The construction of the body portion 120, which is generally cylindrical shaped in this embodiment, is the same as described above for the play toy 10 in FIGS. 1-2. Use of the play toy 100 to produce the two distinctly different audible noises or sounds by compression of the body portion 120 is as described above for the play toy 10.

The other portions of the play toy 100 not corresponding to the body portion 120 (e.g., head, ears, hands and tail portions of the animal character) are formed using the same fabric material as described above for the body portion 120 of the play toy 10. For example, when a plush fabric material is used to form the outer surface of all portions of the play toy 100, the play toy 100 provides a plush toy which is extremely user friendly. This is due, in part, to the characteristic of plush toys which include a soft padded body providing a pleasant feel or touch, which enhances the play value of the play toy.

The portions of the play toy 100 other than the body portion 120 may be filled with a suitable filler material including cotton, synthetic fibers, and the like. It will be appreciated by those skilled in the art, however, that the sound producing means described above for the play toy 10 may be incorporated in any one or all of the other portions of the play toy 100 in place of or in addition to the body portion 120. For example, the sound producing means may be incorporated in the body portion 120 and/or in the head portion and/or in one or both of the hand portions and/or in one or both of the ear portions, and combinations thereof, for example. Alternatively, the sound producing means as described above for the play toy 10 may be incorporated into one of more of the portions of the play toy 100 and omitted from the body portion 120. It will also be appreciated that the second noise making device 16 for the character play toy 100 may be selected so that it is configured to generate a sound simulating the characteristic sound made by the particular animate figure which the play toy 100 represents (e.g., a particular animal figure), thereby providing enhanced amusement and interest to the user.

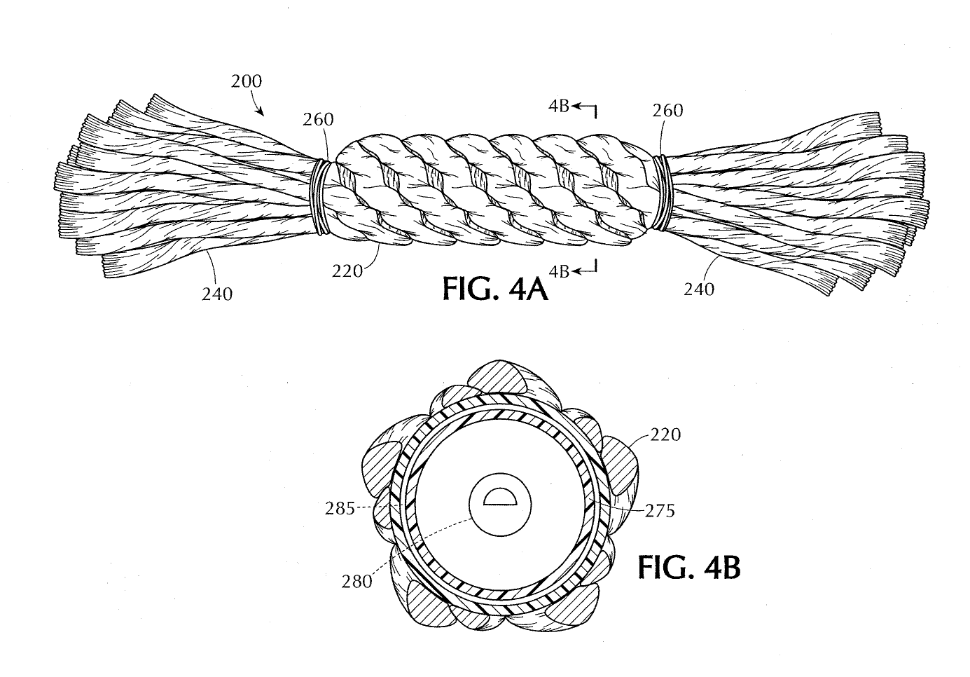

FIGS. 4A-4B show a second embodiment of the play toy, generally designated at 200, according to the present invention. The play toy 200 comprises a tubular braided body 220 and sound producing means incorporated in a cavity or space 285 within the braided body 220.

As shown in FIG. 4A, the braided body 200 is fabricated by braiding together multiple (e.g., six) pieces or strands 240 of a fabric material. These strands may be braided by hand or using a corresponding braiding machine. In the present disclosure, the term “strand” refers to a machine-woven fabric produced from respective fibers or threads. In a preferred embodiment, each of the strands 240 is made of a rope material that is rot and mildew resistant. Such materials include natural fibers and synthetic fibers (e.g., cotton, nylon, polyester).

FIG. 4B is a cross-sectional view taken along the line 4B-4B in FIG. 4A. As shown in FIG. 4B, the sound producing means comprises a sound producing component or noise making device 275 incorporated in the space 285 of the braided body 220 for producing a distinct audible noise or sound when activated. In this embodiment, the noise making device 275 is a shaker which, when shaken, produces via a noise element 280 an audible squeaky, whistling or rattling sound that projects through the braided body 220, providing amusement and/or interest to the user. The shaker 275, characterized with the foregoing construction and mode of operation, is well-known in the art and is incorporated herein by reference.

The incorporation of the noise making device 275 inside the braided body 220 is accomplished during the braiding of the strands 240 of fabric material. Stated otherwise, the strands 240 are braided over the noise making device 275. Upon completion of the final braid(s), each end of the braided body 220 is secured using a suitable securing member 260, as shown in FIG. 4A, which may be formed of the same fabric material used for the strands 240. This provides each end of the play toy 200 with unbraided, loose strands 240 that are free to be displaced in a swinging or flapping fashion during use of the play toy 200 to further enhance the amusement and/or interest effect to the user of the play toy.

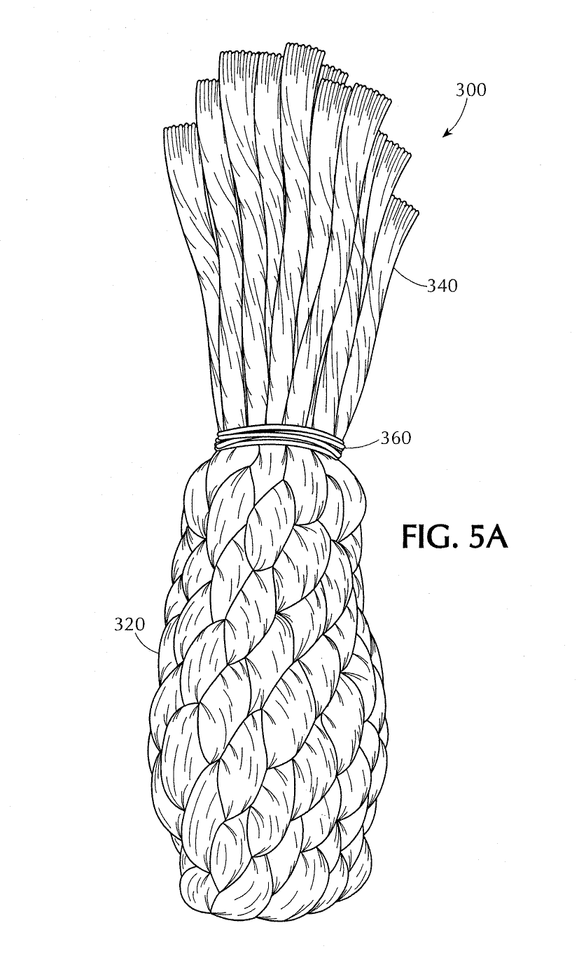

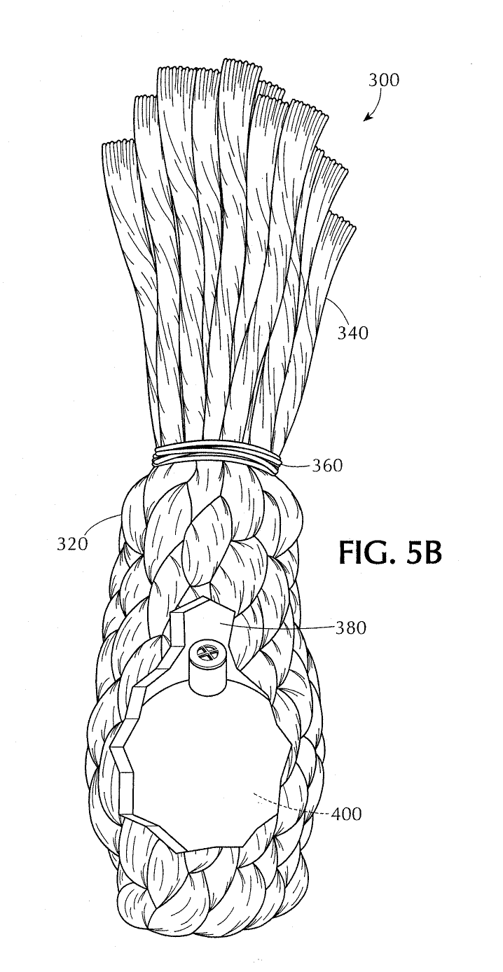

FIGS. 5A-5B show a third embodiment of the play toy, generally designated at 300, according to the present invention. The play toy 300 comprises a tubular braided body 320 and sound producing means incorporated in a cavity or space 380 within the braided body 320.

As shown in FIG. 5A, the braided body 330 is fabricated by braiding together multiple pieces or strands 340 of a fabric material, as described above for the braided body 220 of the play toy 200 in FIGS. 4A-4B. The material for each strand 340 is as described above for the embodiment of FIGS. 4A-4B.

FIG. 5B is a partial cross-sectional view showing the sound producing means of the play toy 300 according to the third embodiment. The sound producing means comprises a sound producing component or noise making device 400 incorporated in the space 380 of the braided body 320 for producing a distinct audible noise or sound when activated. In this embodiment, the noise making device 400 is of the type which produces or emits an audible squeaking or whistling sound upon being compressed or squeezed, and which returns to an uncompressed state after compression so that it is again ready to be compressed to produce the audible sound. The audible squeaking or whistling sound projects through the braided body 320, providing amusement and/or interest to the user. The noise making device 400, characterized with the foregoing construction and mode of operation, is well-known in the art and is incorporated herein by reference.

The incorporation of the noise making device 400 inside the braided body 320 is accomplished during the braiding of the strands 340 of fabric material. Stated otherwise, the strands 340 are braided over the noise making device 400. Upon completion of the final braid(s), one end of the braided body 320 is secured using a suitable securing member 360, as shown in FIGS. 5A-5B, which may be formed of the same fabric material used for the strands 340. This provides one end of the play toy 300 with unbraided, loose strands 340 that are free to be displaced in a swinging or flapping fashion during use of the play toy 300 to further enhance the amusement and/or interest effect to the user of the play toy.

It will be appreciated that in the embodiment of FIGS. 4A-4B both ends of the play toy 200 is provided with unbraided strands 240, and in the embodiment of FIGS. 5A-5B only one end is provided with unbraided strands 340. It will be appreciated by those skilled in the art that the play toy 200 may be configured similarly to the play toy 300 so that only one end has the unbraided strands 240, and that the play toy 300 may be configured similarly to the play toy 200 so that both ends have the unbraided strands 340. Alternatively, each of the play toys 200 and 300 may be configured so that they are not provided with unbraided strands on either end, and the ends are instead terminated with corresponding braided strands in a manner similar to the unbraided end of the play toy 300 (i.e., the lower end of the play toy 300 shown in FIGS. 5A-5B).

In the foregoing embodiments shown in FIGS. 4A-4B and 5A-5B, the number of braided strands that form the corresponding braided body may be selected in accordance with the desired size of the resulting braided body. In modified embodiments, one or more strands of the braided body may have pre-selected color patterns or insignia. Coloring of the respective strands may be obtained by using pre-colored component threads or by various printing techniques.

The bodies 220 and 320 of the play toys 200 and 300, respectively, may be braided to have a pre-selected cross-sectional shape other than as shown in FIGS. 4A-4B and 5A-5B (for example, generally square, rectangular, circular, triangular, or octagonal cross-sectional shape, and the like) and arranged in a pre-selected structural configuration other than as shown in FIGS. 4A-4B and 5A-5B. Alternatively, either or both of the play toys 200, 300 may be configured three-dimensionally to form an animate figure in a manner similar to the play toy 200 shown in FIG. 3, except that each body part is formed as a corresponding braided body 220 and 320 with the corresponding noise making device incorporated therein, as described above for FIGS. 4A-4B and 5A-5B.

It will be appreciated that the rope material (e.g., nylon rope) forming the braided body of each play toy 200 and 300 described above with reference to FIGS. 4A-4B an 5A-5B, respectively, cleans and flosses the teeth of the animal pet (e.g., a dog) during repeated chewing and gnawing on the play toy while the noise or sound generated by the corresponding noise making device maintains the pet's interest. Thus, as the pet plays with the toy for extended periods of time and tries to activate the noise making device by biting down on the rope material, a teeth cleaning effect is achieved that is beneficial to the pet's oral health as it strengthens and exercises the pet's teeth and jaws. The biting (chewing and gnawing) action tends to scrape tartar, plaque, and debris from the pet's teeth. Thus, the incorporation of the noise making device within the braided body of the play toy according to the present invention effectively maintains the pet's interest in playing with the play toy for extended periods of time, thereby enhancing the teeth cleaning benefit provided by the braided rope material.

In the foregoing embodiments, the plush material is preferably a hypoallergenic plush material that is soft to the touch, such as sheepskin, fleece, felt, cotton, velour, boa fabric, tricot fiber, polyester fiber, cotton/polyester blends, or a combination thereof. Both elastic and inelastic types of plush materials are suitable.

The play toys described above are suitable for pets for playing fetch and pulling, such as dogs. The plush toys, in particular, are very soft and well suited for puppies with new developing teeth, and add a different sensation in a pet's mouth from hard materials like rubber and stiffer nylon fabrics. Furthermore, plush materials also allow for the creation of figures and characters such as those described above with reference to FIG. 3. Additionally, the materials and construction of the play toys according to the present invention allow for the placement of conventional noise making devices within the various portions of the figures and characters, such as the head, hands/arms, feet/legs and braided body, to emit a distinctive audible crinkle, squeaky, rattle and/or whistling sound when squeezed or shaken and thereby enhance the attractiveness of the play toy.

The play toys described above are also suitable for use by small children during play. As the braided bodies are generally thin and narrow, they can be easily grasped and manipulated by small hands of children and by children with special needs having immature grips. The play toys according to the present invention, including the plush toys, can also be held by children with one hand, whereas a large plush doll, for example, would require two hands.

Those skilled in the art will readily appreciate that the bodies of the play toys of the present invention may also be used to fabricate other types of play toys for pets and children. For example, the body 12 in FIGS. 1-2, the body part 120 in FIG. 3, and the braided bodies 220 and 320 in FIGS. 4A-4B and 5A-5B may be configured as bone-shaped objects used as chew toys or disc-shaped flying objects used as fetch toys, as well as various objects, characters, and animate and inanimate figures for use by children during play. Such play toys may also be scaled to accommodate the pets and children of different age or size.

Although described above with a specific application to a play toy for children and animals, the play toy of the present invention is also applicable as an advertising device. For example, the body 12 (FIGS. 1-2), the body part 120 (FIG. 3), the braided body 220 (FIGS. 4A-4B) and the braided body 320 (FIGS. 5A-5B) of the play toys 10, 100, 200 and 300, respectively, can be imprinted or embroidered with decorative designs or advertising indicia, such as a company name or logo, an advertising message, by using, for example, a printing or an embroidering process prior or subsequent to assembly of the play toy. Alternatively, instead of imprinting or embroidering indicia, one or more decals containing indicia may be attached to one or both of the foregoing body or body parts of the play toys 10, 100, 200 and 300. The visual representations add desired decorative and aesthetic effects to the play toys for attracting attention, which is particularly advantageous when the play toys are used as an advertising or promotional item.

The previous description of the invention is provided to enable any person skilled in the art to make or use the invention. Various modifications to the invention will be readily apparent to those skilled in the art, and the generic principles defined herein may be applied to other variations without departing from the spirit or scope of the invention. Thus, the invention is not intended to be limited to the examples described herein but is to be accorded the widest scope consistent with the principles and novel features disclosed herein.

What is claimed is:

1. A play toy comprising: a body; and sound producing means disposed in the body for producing a plurality of distinctly different audible noises or sounds.

2. A play toy according to claim 1; wherein the body comprises a covering made of a plush material.

3. A play toy according to claim 1; wherein the sound producing means comprises a first noise making device for producing a first audible sound and a second noise making device mounted on the first noise making device for producing a second audible sound different from the first audible sound.

4. A play toy according to claim 3; wherein the second noise making device is mounted directly on the first noise making device.

5. A play toy according to claim 3; wherein the first noise making device comprises a compressible tubular member which, upon compression, produces the first audible sound while changing a volume within the tubular member to generate within the tubular member an air flow that activates the second noise making device to produce the second audible sound simultaneously with the first audible sound.

6. A play toy according to claim 5; wherein the second noise making device is mounted directly on the first noise making device.

7. A play toy according to claim 5; wherein the first noise making device comprises a recycled plastic water bottle with its open end sealed.

8. A play toy according to claim 7; wherein the body comprises a covering made of a fabric material; and wherein second noise making device comprises a squeak device that produces the second noise in the form of a squeaking sound when the recycled plastic water bottle is compressed via the covering.

9. A play toy comprising: a plurality of parts connected together to form a three-dimensional-shaped play toy, one of the parts comprising a body and sound producing means disposed in the body for producing a plurality of distinctly different audible noises.

10. A play toy according to claim 9; wherein the sound producing means comprises a first noise making device for producing a first audible sound and a second noise making device mounted on the first noise making device for producing a second audible sound different from the first audible sound.

11. A play toy according to claim 10; wherein the first noise making device comprises a compressible tubular member which, upon compression, produces the first audible sound while varying a volume within the tubular member to generate within the tubular member an air flow that activates the second noise making device to produce the second audible sound.

12. A play toy according to claim 11; wherein the second noise making device is mounted directly on the first noise making device.

13. A play toy according to claim 11; wherein the first noise making device comprises a recycled plastic water bottle.

14. A play toy comprising: a plurality of strands of materials braided together to form a braided body having a pre-selected cross-sectional shape; and sound producing means disposed in the braided body for producing an audible noise or sound upon movement of the sound producing means via the braided body.

15. A play toy according to claim 14; wherein the strands of material comprise strands of rope.

16. A play toy according to claim 14; wherein the sound producing means comprises a squeak device that produces the second noise in the form of a squeaking sound when the squeak device is moved via the braided body.

17. An advertising device comprising: a play toy according to claim 1; and advertising indicia disposed at least on the body of the play toy.

18. An advertising device comprising: a play toy according to claim 9; and advertising indicia disposed at least on the body of the play toy.

19. An advertising device comprising: a play toy according to claim 14; and advertising indicia disposed at least on the body of the play toy.
